(19) United States
(12) Patent Application Publication
(10) Pub. No.: US 2026/0087431 A1
(43) Pub. Date: Mar. 26, 2026

(54) SYSTEMS AND METHODS FOR GENERATING A HIERARCHICAL REPRESENTATION OF A PLURALITY OF PRODUCTS

(71) Applicant: Palantir Technologies Inc., Denver, CO (US)

(72) Inventors: Simon Dobers, Munich (DE); Sebastian Münchow, Wiesendangen (CH); Andy Chen, Munich (DE); Leo Razumovsky, Vienna (AT); Daisy Sellem, Levallois-Perret (FR); Jonas Bernsdorff, Munich (DE)

(21) Appl. No.: 18/982,862

(22) Filed: Dec. 16, 2024

Related U.S. Application Data
(60) Provisional application No. 63/699,309, filed on Sep. 26, 2024.

(51) Int. Cl. G06Q 10/0631; G06F 40/30

(52) U.S. Cl. CPC G06Q 10/06315; G06F 40/30

(57) ABSTRACT

In some examples, systems and methods for generating a hierarchical representation are provided. An example method includes receiving a plurality of purchase orders, generating a plurality of embeddings based on the plurality of purchase orders, clustering the plurality of embeddings into one or more embedding subsets based on a semantic similarity between each embedding of the plurality of embeddings and each other embedding of the plurality of embeddings, and identifying a plurality of labels for the plurality of embedding subsets. In some examples, the method includes generating the hierarchical representation such that the plurality of labels forms a tier in the hierarchical representation. In some examples, subsequent iterations of one or more aspects of the method can be performed to generate additional tiers in the hierarchical representation, where the plurality of labels from a preceding iteration can be used to generate the embeddings for a current iteration.

### CROSS REFERENCE TO RELATED APPLICATIONS

This application claims priority to U.S. Provisional Application No. 63/699,309, entitled “SYSTEMS AND METHODS FOR GENERATING A HIERARCHICAL REPRESENTATION OF A PLURALITY OF PRODUCTS,” and filed on Sep. 26, 2024, which is incorporated by reference herein for all purposes in its entirety.

### TECHNICAL FIELD

Certain embodiments of the present disclosure relate to generating a hierarchical representation. More particularly, certain embodiments of the present disclosure relate to generating a hierarchical representation of a plurality of products.

### BACKGROUND

A hierarchical representation can be a way of organizing information in a structure where each element is placed according to its relationship to other elements. The hierarchical representation can resemble a tree, a graph, or a pyramid, for example, with a top level representing a most general category, and subsequent levels breaking down into more detailed categories.

Hence, it is desirable to improve techniques for generating hierarchical representations for a plurality of products.

### SUMMARY

Certain embodiments of the present disclosure relate to generating a hierarchical representation. More particularly, certain embodiments of the present disclosure relate to generating a hierarchical representation of a plurality of products.

At least some aspects of the present disclosure are directed to a method for generating a hierarchical representation of a plurality of products. In some examples, the method includes (a) receiving a plurality of purchase orders comprising a plurality of descriptions. In some examples, each purchase order of the plurality of purchase orders includes at least one description of the plurality of descriptions. In some examples, the method further includes (b) providing the plurality of descriptions of the plurality of purchase orders to a machine-learning model. In some examples, the machine-learning model is trained (e.g., pre-trained) to generate a respective embedding for each description of the plurality of descriptions of the plurality of purchase orders. In some examples, the method further includes (c) receiving, from the machine-learning model, a plurality of embeddings. In some examples, each embedding of the plurality of embeddings corresponds to a respective description of the plurality of descriptions of the plurality of purchase orders. In some examples, the method further includes (d) clustering the plurality of embeddings into one or more embedding subsets based on a semantic similarity between each embedding of the plurality of embeddings and each other embedding of the plurality of embeddings. In some examples, each embedding subset of the one or more embedding subsets includes one or more embeddings of the plurality of embeddings. In some examples, the method further includes (e) identifying, using a large language model, a plurality of labels for the plurality of embedding subsets. In some examples, each label of the plurality of labels corresponds to a respective embedding subset of the plurality of embedding subsets, and each label of the plurality of labels indicates the respective embedding subset of the plurality of embedding subsets for which the label was identified. In some examples, steps (b) through (e) are repeated at least once, using the plurality of labels from the latest iteration of step (e) as the plurality of descriptions in step (b). In some examples, the method further includes (g) generating the hierarchical representation of the plurality of purchase orders. In some examples, the plurality of labels from the first iteration of steps (b) through (e) form a first tier in the hierarchical representation, and the plurality of labels from each subsequent iteration of steps (b) through (e) form a respective other tier in the hierarchical representation. The method is performed using one or more processors.

At least some aspects of the present disclosure are directed to a system for generating a hierarchical representation of a plurality of purchase orders. In some examples, the system includes one or more processors, and one or more memories storing instructions that, when executed by the one or more processors, cause the system to perform a set of operations. In some examples, the set of operations include: (a) receiving a plurality of purchase orders comprising a plurality of descriptions. In some examples, each purchase order of the plurality of purchase orders includes at least one description of the plurality of descriptions. In some examples, the set of operations further includes (b) providing the plurality of descriptions of the plurality of purchase orders to a machine-learning model. In some examples, the machine-learning model is trained to generate a respective embedding for each description of the plurality of descriptions of the plurality of purchase orders. In some examples, the set of operations further includes (c) receiving, from the machine-learning model, a plurality of embeddings. In some examples, each embedding of the plurality of embeddings corresponds to a respective description of the plurality of descriptions of the plurality of purchase orders. In some examples, the set of operations further includes (d) clustering the plurality of embeddings into one or more embedding subsets based on a semantic similarity between each embedding of the plurality of embeddings and each other embedding of the plurality of embeddings. In some examples, each embedding subset of the one or more embedding subsets includes one or more embeddings of the plurality of embeddings. In some examples, the set of operations further includes (e) identifying, using a large language model, a plurality of labels for the plurality of embedding subsets. In some examples, each label of the plurality of labels corresponds to a respective embedding subset of the plurality of embedding subsets, and each label of the plurality of labels indicates the respective embedding subset of the plurality of embedding subsets for which the label was identified. In some examples, operations (b) through (e) are repeated at least once, using the plurality of labels from the latest iteration of operation (e) as the plurality of descriptions in operation (b). In some examples, the set of operations further includes (g) generating the hierarchical representation of the plurality of purchase orders. In some examples, the plurality of labels from the first iteration of operations (b) through (e) form a first tier in the hierarchical representation, and the plurality of labels from each subsequent iteration of operations (b) through (e) form a respective other tier in the hierarchical representation.

At least some aspects of the present disclosure are directed to a method for generating a hierarchical representation of a plurality of purchase orders. In some examples, the method includes (a) receiving a plurality of purchase orders comprising a plurality of product descriptions. In some examples, each purchase order of the plurality of purchase orders includes at least one product description of the plurality of product descriptions. In some examples, the method further includes: (b) generating a plurality of embeddings. In some examples, each embedding of the plurality of embeddings corresponds to a respective product description of the plurality of product descriptions of the plurality of purchase orders. In some examples, the method further includes (c) clustering the plurality of embeddings into one or more embedding subsets based on a semantic similarity between each embedding of the plurality of embeddings and each other embedding of the plurality of embeddings. In some examples, each embedding subset of the one or more embedding subsets includes one or more embeddings of the plurality of embeddings. In some examples, the method further includes (d) categorizing, using a large language model, each embedding subset of the plurality of embedding subsets into a respective category of a plurality of categories. In some examples, each category of the plurality of categories corresponds to a respective embedding subset of the plurality of embedding subsets, and each category of the plurality of categories indicates the respective embedding subset encompassed by the category. In some examples, steps (b) through (d) are repeated at least once, using the plurality of categories from the latest iteration of step (d) as the plurality of descriptions in step (b). In some examples, the method further includes (f) generating the hierarchical representation of the plurality of purchase orders. In some examples, the plurality of categories from the first iteration of steps (b) through (d) form a first tier in the hierarchical representation, and the plurality of categories from each subsequent iteration of steps (b) through (d) form a respective other tier in the hierarchical representation. The method is performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates a simplified diagram showing a method for generating a hierarchical representation of a plurality of products, according to certain embodiments of the present disclosure.

FIG. 2 illustrates an example system for generating a hierarchical representation of a plurality of products, according to certain embodiments of the present disclosure.

FIG. 3 illustrates an example flow for generating a hierarchical representation of a plurality of products, according to certain embodiments of the present disclosure.

FIG. 4 illustrates an example user interface, according to certain embodiments of the present disclosure.

FIG. 5 illustrates an example user interface, according to certain embodiments of the present disclosure.

FIG. 6 illustrates a simplified diagram showing a computing system for generating a hierarchical representation of a plurality of products, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are very inefficient, in terms of time and computing resources, at creating product hierarchies. For example, conventional systems often rely on manual processes that are time-consuming and inefficient, particularly when handling large amounts (e.g., thousands, millions, billions, etc.) of purchase orders. Conventional systems may also include legacy systems that have been around for many years and have significant data errors due to inconsistent data entry practices that have compounded over time. Manually standardizing this data is a daunting task that can introduce further inaccuracies, for example. Additionally, some conventional systems often rely on outdated information technology systems that cannot integrate with modern analytic tools, making data extraction and conversion a technically demanding and time-consuming process. As another example, conventional systems may be unable to quickly update product information and determine the impact of those updates on procurement, amidst changing supply chains.

Various embodiments of the present disclosure can achieve benefits and/or improvement by a computing system for generating product hierarchies of products. In some embodiments, benefits include improved accuracy for organizing purchase orders. For example, by generating embeddings for purchase order descriptions and analyzing a semantic similarity between the embeddings, the purchase order descriptions can be clustered and labelled, automatically. In some embodiments, such functionality can significantly improve the accuracy with which purchase orders are organized. Further, in some embodiments, the process of generating embeddings, clusters, and labels can be performed iteratively, to efficiently categorize groupings of purchase orders at various granular levels of abstraction. In some embodiments, having purchase orders categorized at various granular levels of abstraction improves user experience, as well as allowing for procurement analysis to be efficiently and accurately performed, for should costing, demand planning, supplier risk analysis, and vendor changes, amongst other applications. Additional and/or alternative benefits should be recognized by those of ordinary skill in the art, at least in light of the teachings provided herein.

In some embodiments, a granular understanding of a company's product hierarchy and decomposition is helpful for enabling a spectrum of business functions, such as accurate should-costing, which can be useful for cost optimization and supplier negotiations, carbon dioxide (CO2) transparency workflows that are increasingly mandatory for regulatory compliance and corporate responsibility, and/or comprehensive risk management within a supply chain where insights into every component's sourcing and potential vulnerabilities are helpful to bolster a company's resilience against supply chain disruptions. In some embodiments, a product hierarchy with sufficient level of detail empowers a company to strategically navigate financial, environmental, and/or operational challenges with precision and foresight.

In some examples, creating a granular product hierarchy for an established complex organization with millions of purchase orders and no preexisting mapping is challenging for a plurality of reasons. For example, creating a granular product hierarchy can be challenging due to the volume and complexity of data a company receives. In some embodiments, an established company with a long history can have a vast amount of transactional data, encompassing numerous products and components. In some embodiments, sorting through millions of purchase orders to extract and organize relevant information requires substantial time and resources, as well as advanced data management tools.

As another example, creating a granular product hierarchy can be challenging due to data inconsistencies and inaccuracies. In some embodiments, over the years, changes in data entry practices, systems, and personnel can lead to inconsistencies, errors, and incomplete data within an organization. In some embodiments, standardizing this data to achieve a uniform and accurate product hierarchy is a complex task that can necessitate data cleansing and validation.

As another example, creating a granular product hierarchy can be challenging due to legacy systems that exist within organization. In some embodiments, older companies may rely on outdated information technology systems that are not designed to interact seamlessly with modern data analytics tools. In some embodiments, extracting data from these systems and converting it into a usable format can be a technically demanding and time-consuming process.

As another example, creating a granular product hierarchy can be challenging due to change management. In some embodiments, implementing a new structure for product hierarchy can be met with resistance from employees accustomed to legacy processes. In some embodiments, this human factor can require careful management to ensure buy-in and proper training on newly implemented systems.

As another example, creating a granular product hierarchy can be challenging due to resource intensity. In some embodiments, the process of mapping out a product hierarchy accurately is resource-intensive, requiring skilled personnel, technology investment, and significant time commitment, which can be difficult for businesses to allocate if they are already operating at a certain capacity.

As another example, creating a granular product hierarchy can be challenging due to evolving supply chains. In some embodiments, as products and markets evolve, so do supply chains. In some embodiments, keeping a product hierarchy up-to-date with these changes in a supply chain add another layer of complexity to creating a granular product hierarchy.

According to some embodiments, given these challenges, creating a detailed product hierarchy in an established company with a sprawling history of transactions creates unique technical challenges, particularly when aiming to limit manual labor to particular tasks, such as a validation of data.

According to some embodiments, procurement departments can have different ways to structure and/or cluster their purchases. In some examples, these ways involve concepts like materials or commodity groups. In some examples, these concepts are heavily biased and do not necessarily capture all relevant parts of product groupings. According to some embodiments, a product ontology is provided to create unbiased clustering and/or groupings starting simply from purchase order descriptions (which are often times hard to process, as they might contain different descriptions for the same item or contain wrong spellings/shorthand descriptions). In some examples, mechanisms provided herein use machine-learning models, such as large language models (LLMs) to cope with different languages/spellings and inconsistencies across purchase orders. In some embodiments, the LLMs are use for generating completions and/or embeddings.

In some embodiments, a hierarchical representation of products represents a single source of truth for a procurement department. In some examples, the hierarchical representation can act as a glue between existing concepts like materials and/or commodity groups. In some examples, the unbiased clustering allows entities to re-evaluate existing concepts and/or to drive decisions at different levels of granularity.

According to some embodiments, techniques provided herein include computing embeddings of purchase order descriptions, such as using an embedding generator and/or a machine-learning model (e.g., a language model, a generative artificial intelligence (AI) model, an LLM). In some examples, the embedding computations can be improved by including additional information, such as vendor descriptions, existing categories, and/or other contextual information that may be recognized by those of ordinary skill in the art.

In some examples, the techniques include repeatedly run a clustering algorithm in an embedding space to determine an optimal number of clusters of the computed embeddings. In some examples, the techniques include clustering purchase orders based on their embeddings and the determined optimal number of clusters. In some examples, an LLM is used to identify reasonable cluster names for grouped purchase orders. In some examples, a hierarchy is generated using the identified cluster names. In some examples, an LLM is used to identify clusters of product categories. For example, the products Fruits and Bread could fall into the same cluster of product categories. In some examples, names are identified for the clusters of products categories, such as by using an LLM. In some examples, the steps of identifying clusters of product categories and identifying numbers for the cluster of product categories are repeated multiple times to get multiple suggestions of product hierarchies. In some examples, a majority answer (e.g., the most consistent answer across the multiple suggestions) is chosen to determine the final product hierarchy. In some examples, the processes provided herein contains techniques to avoid duplicates, ensure consistency, and/or ensure data quality throughout the processes.

According to some embodiments, techniques are provided that can be used at any procurement department without the need for reconfiguration and/or adaptation. In some examples, the techniques provide a harmonization layer (e.g., a material harmonization layer) to power multiple use cases, such as should costing, demand planning, supplier risk analyses, and/or vendor change implications. In some embodiments, a harmonization layer is configured to link different names for a product, different abbreviations for the product, product names in different languages for the product, different representations indicating the product, and/or the like. For example, during tenders, knowledge about the price of similar and/or the same products being tendered is useful to get an estimation of realistic cost. In some examples, the harmonization of a product layer in the hierarchical representation provided by techniques herein enables a user to use this knowledge in generating outputs, reports, action plans, tenders and/or the like.

As another example, based on prior usage of product and planned projects, a consumption of material can be planned for the future. In some examples, the consumption of materials can be calculated at one or more levels of granularity (e.g., at varying levels in the hierarchical representation described herein). For example, a consumption of materials can be calculated for a specific tool (e.g., a screwdriver) and/or a consumption of materials can be calculated for all of the tools (e.g., a screwdriver, a saw, a hammer, etc.). More granular levels (e.g., a specific type of screwdriver) and/or less granular levels could also be used to calculate the consumption of materials. In some examples, with a harmonized material layer, a planned demand can be compared with a current stock and/or prior orders.

As another example, companies often purchase multiple products for a same category of products from a same supplier. In some examples, if the supplier is unable to fulfill orders, it can be a major risk for not just a particular product, but the entire product category in which that particular product is grouped. In some examples, with a harmonization layer, the impact of the supplier's inability to fulfill orders can be calculated and actions for mitigations can be recommended and/or taken.

As another example, if a company decided to discontinue their business relationship with a vendor, mechanisms provided herein can be used to indicate which products would have to be reprocured. In some examples, mechanisms provided herein can be used to determine what is the impact if a vendor cannot deliver one or more products anymore due to a supply chain challenge.

In some examples, a robust product hierarchy and/or categorization system is important for numerous procurement use-cases. In some examples, techniques provided herein can significantly reduce the manual time spent creating the product hierarchies and improve upon the accuracy and type of information that is provided in the product hierarchies.

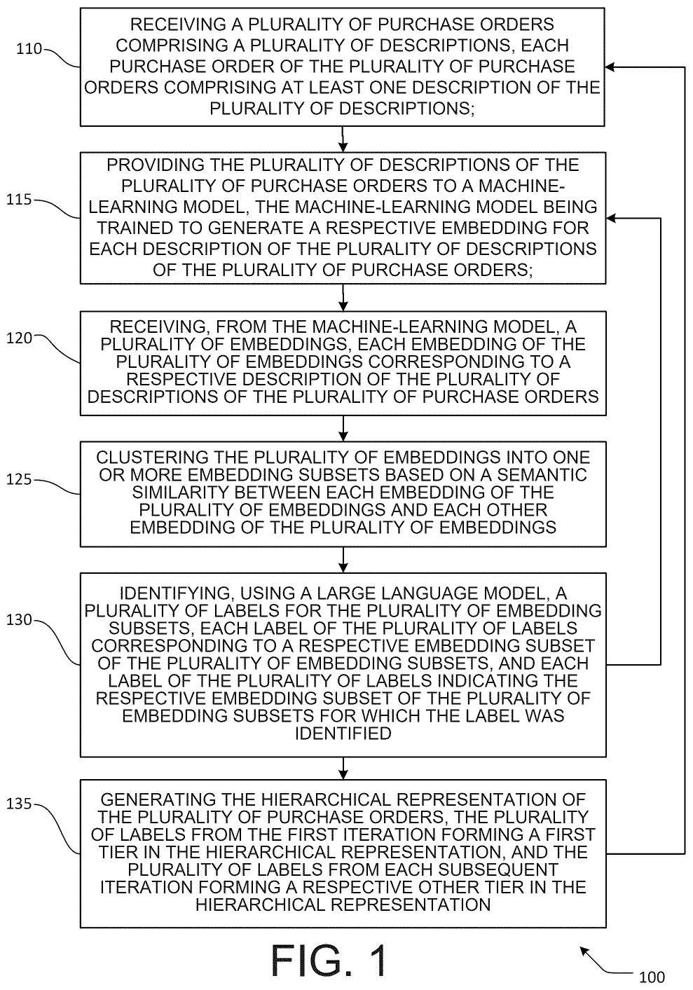

FIG. 1 is a simplified diagram showing a method 100 for generating a hierarchical representation according to certain embodiments of the present disclosure. For example, the hierarchical representation can be a hierarchical representation of a plurality of products. This diagram is merely an example. One of ordinary skill in the art would recognize many variations, alternatives, and modifications. The method 100 for generating a hierarchical representation includes processes 110, 115, 120, 125, 130, and 135. Although the above has been shown using a selected group of processes for the method 100 for generating a hierarchical representation, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 100 are performed by a system (e.g., the computing system 600). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 110, a plurality of purchase orders including a plurality of descriptions are received. In some examples, each purchase order of the plurality of purchase orders includes at least one description of the plurality of descriptions. In some examples, a purchase order can include a plurality of descriptions. In some examples, a relatively large number of purchase orders are received, such as millions of purchase orders. In some examples, the purchase orders are in different languages and/or different formats compared to each other.

In some examples, the purchase orders includes one or more product descriptions, product numbers, vendor descriptions, abbreviations, pricing, and/or quantities. For example, the product descriptions can include a name of a product, a size of a product, an image of a product, and/or a weight of a product. In some examples, a vendor description can include a vendor's name, a vendor's address, a vendor's phone number, and/or a vendor's logo. Additional and/or alternative data that the purchase orders can include should be recognized by those of ordinary skill in the art.

According to some embodiments, at the process 115, the plurality of descriptions of the plurality of purchase orders are provided to a machine-learning model. In some examples, the machine-learning model includes a language model, a generative artificial intelligence (AI) model, an LLM, and/or the like. In some examples, the machine-learning model is trained (e.g., pre-trained) to generate a respective embedding for each description of the plurality of descriptions of the plurality of purchase orders. For example, a first product description can be used to generate a first embedding and a second product description can be used to generate a second embedding different than the first embedding. In some examples, a first vendor description and/or a first product description can be used to generate the first embedding and a second vendor description and/or a second product description can be used to generate the second embedding.

In some embodiments, an embedding is a numerical representation of data in a vector space. In some embodiments, the embeddings can allow a model to process and understand linguistic information in a way that captures semantic meaning (e.g., abstract meaning of language) and relationships between data (e.g., similarities in semantic meaning, based on proximity between embeddings within the vector space).

According to some embodiments, at the process 120, a plurality of embeddings are received from the machine-learning model. For example, the machine-learning model can be part of a software program, which systems described herein can interface with to generate the embeddings. In some examples, the processes 115 and 120 can be performed together to generate (e.g., create, calculate) the plurality of embeddings.

In some examples, each embedding of the plurality of embeddings corresponds to a respective description of the plurality of descriptions of the plurality of purchase orders. In some examples, at least one embeddings corresponds to multiple descriptions, such as when a plurality of descriptions are input to generate a single corresponding embedding representing the plurality of descriptions.

For example, the word “screwdriver” in English and the same word in German may be very close to each other in the embeddings space because they share a common meaning, but in different languages. In such example, the machine-learning model (e.g., an LLM) can understand both languages and know that the words are semantically the same thing, and therefore assign them embeddings (e.g., vector representations of the words) that are close together in a vector space.

According to some embodiments, at the process 125, the plurality of embeddings are clustered into one or more embedding subsets. For example, the plurality of embeddings may be clustered (e.g., grouped, categorized) into the one or more embeddings subsets, based on a semantic similarity between each embedding of the plurality of embeddings and each other embedding of the plurality of embeddings. As an example, the plurality of embeddings may be clustered (e.g., grouped, categorized) into the one or more embeddings subsets, based on a vector distance between every two different embeddings of the plurality of embeddings. In some examples, each embedding subset of the one or more embedding subsets includes one or more embeddings of the plurality of embeddings (e.g., from being grouped by the clustering of process 125).

In some examples, the clustering includes determining the semantic similarity between each embedding of the plurality of embeddings and each other embedding of the plurality of embeddings. In some examples, the semantic similarity between two embeddings is the distance between the two embeddings. In some examples, the distance can be a distance in a vector space. For example, the distance can be a Euclidean distance, a cosine distance, and/or another type of distance measurement recognized by those of ordinary skill in the art.

In some examples, the semantic similarity between each embedding of the plurality of embeddings and each other embedding of the plurality of embeddings is compared to a predetermined threshold. For example, the similarity between embeddings to be grouped together can be an amount of similarity. In some examples, the predetermined threshold is an amount, such as a predetermined distance at which embeddings are determined to be semantically similar.

In some examples, the plurality of embeddings are assigned to the one or more embedding subsets based on the comparison of the semantic similarity between each embedding of the plurality of embeddings and each other embedding of the plurality of embeddings to the predetermined threshold. For example, two embeddings of the plurality of embeddings may be assigned to a first embedding subset based on the two embeddings being semantically similar, and two other embeddings of the plurality of embeddings may be assigned to a second embedding subset based on the two other embeddings being semantically similar to each other, but semantically dissimilar from the two embeddings assigned to the first embedding subset. In some examples, an embedding subset includes a plurality of embeddings. In some examples, an embedding subset includes a single embedding.

According to some embodiments, at process 130, a plurality of labels for the plurality of embedding subsets are identified. In some examples, the process 130 can include categorizing each embedding subset of the plurality of embedding subsets into a respective category of a plurality of categories. In some examples, the plurality of labels are identified using a machine-learning model, such as an LLM. In some examples, the plurality of embedding subsets are classified into categories and the categories are associated with labels. In some examples, the categories are assigned labels, such as via an LLM. In some examples, the labels are from a predetermined library of labels into which the embedding subsets are categorized.

In some examples, LLMs used according to the disclosed techniques have a degree of randomness. In some examples, LLMs can be run multiple times with the same prompt (e.g., five times), to receive multiple answers from the same prompt. In such examples, the multiple answers can have some variation. In some examples, the multiple answers can be provided to an LLM (e.g., an LLM acting in a supervisory role over the provided answers), such that the LLM can look at the multiple answers and determine which answer is the best (e.g., most consistent with the other answers, in terms of the abstract semantic meaning being encompassed by the answers). In some examples, the best answer is the answer that appears most often. In some examples, the best answer is the answer that is closest in semantic similarity to each and/or most of the other answers.

In some examples, techniques provided herein can reduce and/or minimize hallucinations created by LLMs. For example, techniques provided herein can be operating on potential huge data sets, such as millions of purchase orders and purchase order products. In some examples, even a small percentage of hallucinations can negatively impact processing, when the processing is performed at scale. In some examples, using supervisory LLMs and/or multiple iterations of LLM processes described herein (e.g., in a clustering, categorization, and/or labelling step), helps to reduce a degree of hallucinations created by LLMs to improve the consistency and/or accuracy of processing described herein. In some examples, having an undefined bucket for embeddings (e.g., in a clustering, categorization, and/or labelling step) can be another option for reducing a degree of hallucinations.

In some examples, method 100 includes selecting an LLM to use, from a plurality of LLM options, such as based on accuracy of the different LLM models in different use cases. In some examples, an LLM model can be switched out with another LLM model, such as due to accuracy of the different LLM models in different use cases. For example, a first LLM model may be better (e.g., more accurate) at generating embeddings and/or identifying labels over a variety of languages than a second LLM model. As another example, a first LLM model may be better (e.g., more accurate) at generating embeddings and/or identifying labels for a particular language than a second LLM model, such that if a description is provided in the particular language, systems provided herein will know to switch to the first LLM model for generating an embedding and/or identifying labels.

In some examples, each label of the plurality of labels identified at operation 130 corresponds to a respective embedding subset of the plurality of embedding subsets. In some examples, each embedding subset is assigned a different label, such as because if two embedding subsets were semantically similar enough to be assigned the same label, then they would instead be one embedding subset. In some examples, each label of the plurality of labels indicates the respective embedding subsets of the plurality of embedding subsets for which the label was identified. For example, the label can describe the semantic similarity encompassed by the embedding subset. In some examples, if an embedding subset includes a plurality of different types of fruits (e.g., embeddings representing an apple, banana, lemon, etc.), then the label may be “fruits” to describe the semantic similarity (e.g., abstract linguistic meaning) uniting the embeddings within the embedding subset. As another example, if an embedding subset includes a plurality of different types of tools (e.g., embeddings representing a hammer, screwdriver, saw, etc.), then the label may be “tools” to describe the semantic similarity (e.g., abstract linguistic meaning) uniting the embeddings within the embedding subset.

In some examples, the processes 115, 120, 125, and/or 130 can be repeated, using the plurality of labels from the latest iteration of process 130 as the plurality of descriptions in the process 115. For example, by iteratively completing processes 115, 120, 125, and/or 130, using the labels from process 130 as input for the next iteration of the processes, different tiers of a hierarchical representation can be generated.

In some examples, the processes 115 through 130 can be repeated until the clustering of process 125 includes clustering the plurality of embeddings into only one embedding subset based on the semantic similarity. In some examples, having only one embedding subset indicates that no further tiers in a hierarchical representation can be created. In some examples, with only one embedding subset, only one label is identified at process 130, such that all of the embeddings from that iteration are categorized into the same group and no more abstract label is needed to encompass the group with another group (e.g., because there is no other group).

In some examples, the processes 115 through 130 can be repeated until a specified plurality of labels are generated. For example, a specific number of tiers may be desired in the hierarchical representation, and since each plurality of labels (e.g., each set of labels from different iterations of processes 115 through 130) can correspond to a respective tier, having a specified plurality of labels generated can control how many tiers are in the hierarchical representation.

According to some embodiments, at process 135, a hierarchical representation of a plurality of purchase orders is generated. In some examples, the plurality of labels from the first iteration of processes 115 through 130 form a first tier in the hierarchical representation. In some examples, the plurality of labels from the first iteration of processes 115 through 130 form a base tier in the hierarchical representation. In some examples, each subsequent iteration of processes 115 through 130 form a respective other tier (e.g., higher or more abstract tier) in the hierarchical representation. In some examples, a current iteration of processes 115 through 130 forms a more abstract tier than the iteration proceeding the current iteration, such as to generate more abstract categories or labels to categorize the categories or labels from the iteration proceeding the current iteration.

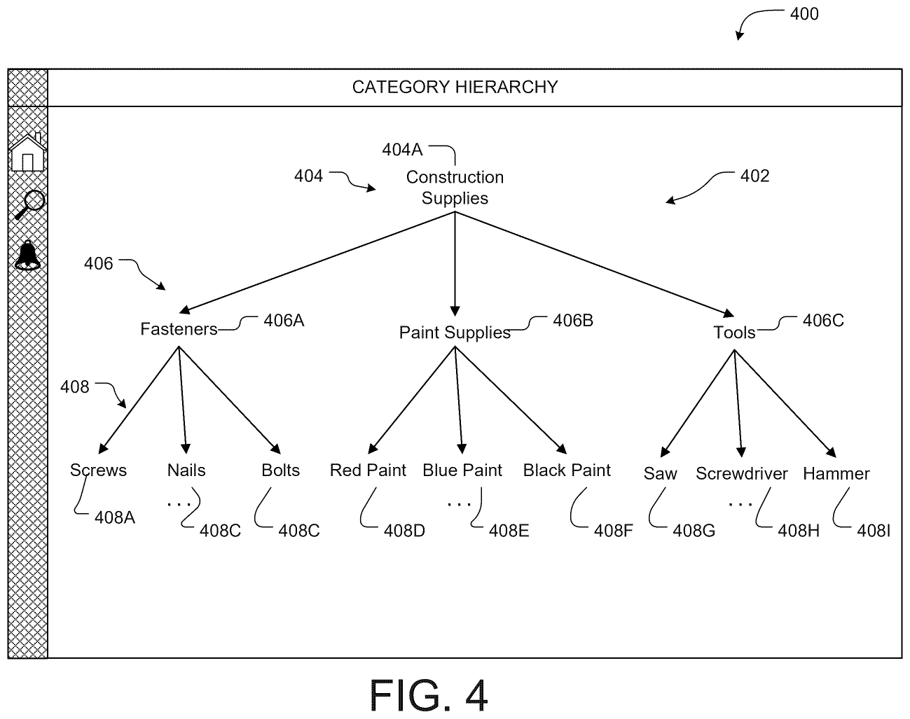

In some examples, the hierarchical representation includes a tree, such as is shown in FIG. 4. In some examples, the hierarchical representation includes a graph and/or a table. In some examples, the hierarchical representation (e.g., including the tree, graph, and/or table) is displayed on a user interface, such as is shown in FIGS. 4 and/or 5.

In some examples, a user can provide input to the user interface to interact with the hierarchical representation. For example, a user may be able to manually edit the hierarchical representation. In some examples, a user may be able to relabel certain categories, redirect edges, reassign products to different groups, or perform other manual edits that may be recognized by those of ordinary skill in the art. In some examples, the user's edits can be used to train the system (and/or a model associated with the system) to provide outputs in accordance with the user's edits, in future processing. In some examples, user intervention can be a form of supervising learning for techniques provided herein. In some examples, the user intervention is provided via a selection, text-input, audio-input, gaze-input, gesture-input, or any other type of user input that may be recognized by those of ordinary skill in the art. In some examples, one or more user interface features (e.g., text box, file upload, button, camera, touchscreen, etc.) may be provided for a user to provide their user input.

In some examples, after a hierarchical representation is generated, new purchase orders can be received by the system, and the hierarchical representation can be updated based on the new purchase orders. For example, new categories may be added based on the new purchase orders, new edges may be created between categories, and new metrics may be calculated based on the purchase orders. In some examples, additional and/or alternatives modifications that may be made when new purchase orders are received may be recognized by those of ordinary skill in the art.

In some examples, different hierarchical representations can be generated for different types of users. For example, a tree structure can be generated for a first type of user (e.g., a technically sophisticated user). In some examples, the first type of user may be more interested than the second type of user in hierarchical relationships between different types of products. In some examples, a bar graph and/or table can be generated for a second type of user (e.g., a buyer). For example, the second type of user may be more interested than the first type of user in prices for products described in the hierarchical representation. In such examples, graphical representations communicating pricing information can be generated for the second type of user.

In some examples, a quantity of a type of product ordered can be identified, such as based on a label of the plurality of labels in at least one tier of the hierarchical representation identifying the type of product ordered and how many embeddings corresponding to the plurality of descriptions of the plurality of purchase orders are in the embedding subset encompassed by the label. In some examples, a number of embeddings corresponding to a type of product indicate a quantity of the type of product amongst the purchase orders used to create the embeddings. In some examples, the quantity of types of products can be used to perform calculations, such as pricing calculations.

In some examples, method 100 includes receiving (e.g., via a user interface, a software interface) an indication of a change in price for a type of product ordered. For example, a user may be simulating changes in costs, based on changing a price for a type of product ordered, based on historical data formed by the embeddings of how much of that type of product has been ordered in the past. In some examples, a cost difference for the quantity of the type of product ordered can be calculated, based on the change in price. In some examples, the cost difference for the quantity of the type of product ordered can be output, such as to notify a user of cost differences from changing the price of a product (e.g., from changing a vendor, negotiating a price change with a vendor, receiving a product discount, having prices increased, etc.).

In some embodiments, method 100 may terminate at process 135. In some embodiments, method 100 may return to process 110 (or any other process from method 100) to provide an iterative loop, such as of receiving a plurality of purchase orders having a plurality of descriptions, creating labels for the purchase orders, and iteratively generating a hierarchical representation describing products in the purchase orders and relationships between them. As discussed above and further emphasized here, FIG. 1 is merely an example. One of ordinary skill in the art would recognize many variations, alternatives, and modifications.

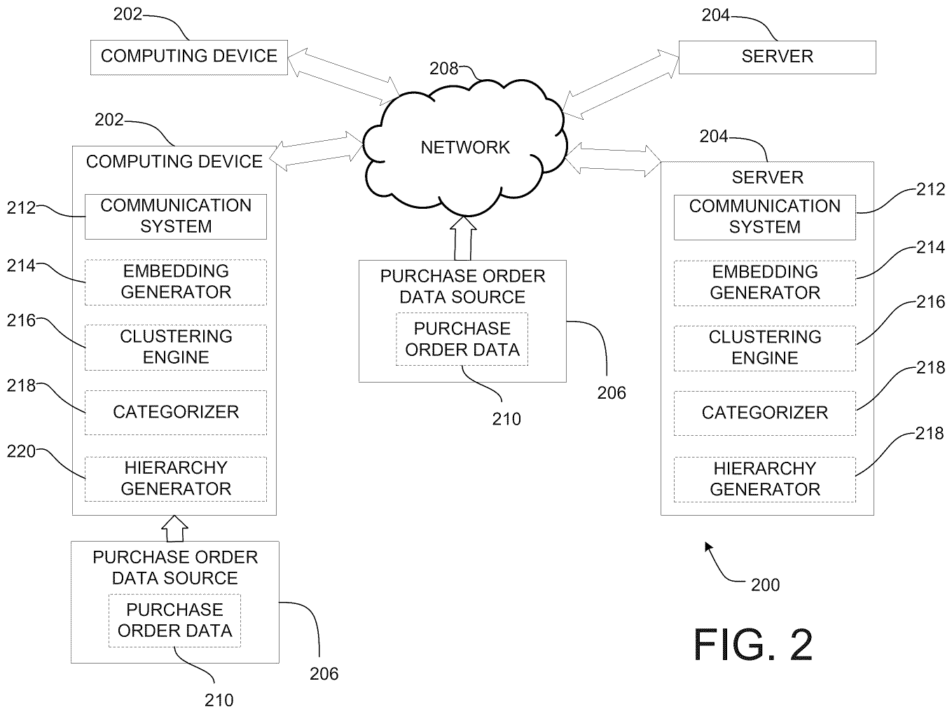

FIG. 2 shows an example of a system 200, in accordance with some aspects of the disclosed subject matter. In some embodiments, the system 200 is a system for generating a hierarchical representation, such as of a plurality of products. FIG. 2 is merely an example. One of the ordinary skilled in the art would recognize many variations, alternatives, and modifications. Although system 200 has been shown using a selected group of components, there can be many alternatives, modifications, and variations. For example, some of the components may be expanded and/or combined. Other components may be inserted into those noted above. Depending upon the example, the arrangement of components may be interchanged with others replaced. Further details of these components are found throughout the present disclosure.

In some embodiments, various components in the system 200 can execute software or firmware stored in non-transitory computer-readable medium to implement various processing steps. In some embodiments, various components and processors of the system 200 can be implemented by one or more computing devices including, but not limited to, circuits, a computer, a cloud-based processing unit, a processor, a processing unit, a microprocessor, a mobile computing device, and/or a tablet computer. In some embodiments, various components of the system 200 can be implemented on a shared computing device. In some embodiments, a component of the system 200 can be implemented on multiple computing devices. In some embodiments, various modules and components of the system 200 can be implemented as software, hardware, firmware, or a combination thereof.

In some embodiments, the system 200 includes one or more computing devices 202, one or more servers 204, one or more purchase order data sources 206 for receiving purchase order data 210, and a communication network or network 208. In some embodiments, the computing device 202 can receive purchase order data 210 from the purchase order data source 206. Additionally, or alternatively, in some embodiments, the network 206 can receive purchase order data 210 from the purchase order data source 206.

In some embodiments, computing device 202 includes one or more communication systems 212, one or more embedding generators 214, one or more clustering engines 216, one or more categorizers 218, and/or one or more hierarchy generators 220. In some embodiments, computing device 202 can execute at least a portion of the embedding generator 214 to generate embeddings based on received purchase order data. In some embodiments, the embedding generator 214 is part of an LLM or other machine-learning model. In some embodiments, computing device 202 can execute at least a portion of the clustering engine 216 to cluster embeddings generated by the embedding generator 214. For example, the clustering engine 216 can cluster the embeddings based on a semantic similarity between each embedding and each other embedding generated by the embedding generator 214.

In some embodiments, computing device 202 can execute at least a portion of the categorizer 218 to identify labels (e.g., categories) for the clustered embeddings from the clustering engine 216. In some examples, the labels are created using an LLM. In some embodiments, computing device 202 can execute at least a portion of the hierarchy generator 220 to generate a hierarchical representation of the plurality of purchase orders. For example, the labels created by the categorizer can form one or more tiers of the hierarchical representation. In some embodiments, the hierarchy generator 220 can create a graphic for display on a user interface, which illustrates hierarchical relationships between one or more aspects of the purchase order data 210.

In some embodiments, server 204 includes one or more communication systems 212, one or more embedding generators 214, one or more clustering engines 216, one or more categorizers 218, and/or one or more hierarchy generators 220. In some embodiments, server 204 can execute at least a portion of the embedding generator 214 to generate embeddings based on received purchase order data. In some embodiments, the embedding generator 214 is part of an LLM or other machine-learning model. In some embodiments, server 204 can execute at least a portion of the clustering engine 216 to cluster embeddings generated by the embedding generator 214. For example, the clustering engine 216 can cluster the embeddings based on a semantic similarity between each embedding and each other embedding generated by the embedding generator 214.

In some embodiments, server 204 can execute at least a portion of the categorizer 218 to identify labels (e.g., categories) for the clustered embeddings from the clustering engine 216. In some examples, the labels are created using an LLM. In some embodiments, server 204 can execute at least a portion of the hierarchy generator 220 to generate a hierarchical representation of the plurality of purchase orders. For example, the labels created by the categorizer can form one or more tiers of the hierarchical representation. In some embodiments, the hierarchy generator 220 can create a graphic for display on a user interface, which illustrates hierarchical relationships between one or more aspects of the purchase order data 210.

Additionally, or alternatively, in some embodiments, computing device 202 can communicate the purchase order data 210 to the server 204 over a communication network 208, which can execute at least a portion of the embedding generator 214, clustering engine 216, categorizer 218, and/or hierarchy generator 220. In some embodiments, the embedding generator 214 executes one or more portions of methods/processes disclosed herein and/or recognized by those of ordinary skill in the art, in light of the present disclosure. In some embodiments, the clustering engine 216 executes one or more portions of methods/processes disclosed herein and/or recognized by those of ordinary skill in the art, in light of the present disclosure. In some embodiments, the categorizer 218 executes one or more portions of methods/processes disclosed herein and/or recognized by those of ordinary skill in the art, in light of the present disclosure. In some embodiments, the hierarchy generator 220 executes one or more portions of methods/processes disclosed herein and/or recognized by those of ordinary skill in the art, in light of the present disclosure.

In some embodiments, computing device 202 and/or server 204 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some embodiments, there may be a plurality of computing device 202 and/or a plurality of servers 204.

In some embodiments, the purchase order data source 206 can be any suitable source of purchase order data (e.g., data generated from a computing device, data stored in a repository, data generated from a software application, data received via user input, etc.) In some embodiments, the purchase order data 210 can be received from memory storing the purchase order data 210 (e.g., local memory of computing device 202, local memory of server 204, cloud storage, portable memory connected to computing device 202, portable memory connected to server 204, etc.). In some embodiments, the purchase order data source 206 can be an application configured to generate purchase order data 210 and provide the purchase order data 210 via a software interface. In some embodiments, the purchase order data source 206 is a source local to computing device 202. In some embodiments, the purchase order data source 206 is a source remote from computing device 202 and can communicate to computing device 202 (and/or server 204) via a communication network (e.g., communication network 208).

In some embodiments, the purchase order data source 206 includes a repository implemented using any one of the configurations described below. In some embodiments, a data repository may include random access memories, flat files, XML files, and/or one or more database management systems (DBMS) executing on one or more database servers or a data center. In some embodiments, a database management system may be a relational (RDBMS), hierarchical (HDBMS), multidimensional (MDBMS), object oriented (ODBMS or OODBMS) or object relational (ORDBMS) database management system, and the like. In some embodiments, the data repository may be, for example, a single relational database. In some embodiments, the data repository may include a plurality of databases that can exchange and aggregate data by data integration process or software application. In some embodiments, at least part of the data repository may be hosted in a cloud data center. In some embodiments, a data repository may be hosted on a single computer, a server, a storage device, a cloud server, or the like. In some embodiments, a data repository may be hosted on a series of networked computers, servers, or devices. In some embodiments, a data repository may be hosted on tiers of data storage devices including local, regional, and central.

In some embodiments, the purchase order data 210 includes product descriptions, product numbers, vendor descriptions, abbreviations, pricing, and quantities. For example, the product descriptions can include a name of a product, a size of a product, an image of a product, and/or a weight of a product. In some examples, a vendor description can include a vendor's name, a vendor's address, a vendor's phone number, and/or a vendor's logo. Additional and/or alternative data that the purchase order data 210 can include should be recognized by those of ordinary skill in the art.

In some embodiments, communication network 208 can be any suitable communication network or combination of communication networks. For example, communication network 208 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some embodiments, communication network 308 can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network (e.g., a corporate or university intranet), any other suitable type of network, or any suitable combination of networks. In some embodiments, communication links (arrows) shown in FIG. 2 can each be any suitable communications link or combination of communication links, such as wired links, fiber optics links, Wi-Fi links, Bluetooth® links, cellular links, satellite links, etc.

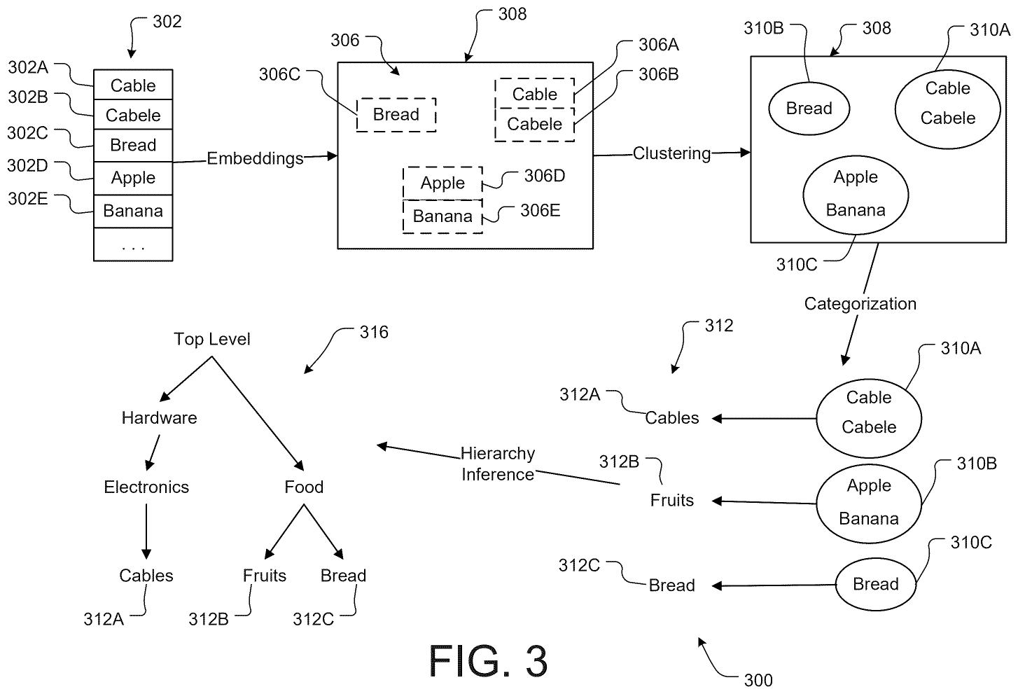

FIG. 3 illustrates an example flow 300 for generating a hierarchical representation of a plurality of products, according to certain embodiments of the present disclosure. In some examples, aspects of the flow 300 are the same or similar as aspects of the method 100 of FIG. 1. In some examples, aspects of the flow 300 are executed by aspects of the system 100.

The flow 300 is merely an example. One of ordinary skill in the art would recognize many variations, alternatives, and modifications. Although the flow has been shown using a selected group of processes for generating a hierarchical representation, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

According to some embodiments, flow 300 includes receiving a plurality of purchase order descriptions 302. In some examples, the plurality of purchase order descriptions 302 include product descriptions, such as names of one or more products. In some examples, a relatively large number of purchase order descriptions can be received, such as millions of purchase order descriptions. In some examples, the purchase order descriptions are in different languages and/or different formats compared to each other.

According to the example flow 300, the plurality of purchase order descriptions include a first purchase order description 302A, a second purchase order description 302B, a third purchase order description 302C, a fourth purchase order description 302D, and a fifth purchase order description 302E. In some of the examples, each of the purchase order descriptions 302A-E include a product name. For example, the first purchase order description 302A is “cable”, the second purchase order description 302B is “cabele” (e.g., the word “cable” but misspelled), the third purchase order description 302C is “bread”, the fourth purchase order description 302D is “apple”, and the fifth purchase order description 302E is “banana.”

According to some embodiments, flow 300 includes computing a plurality of embeddings or vectors 306 in an embedding space or vector space 308, based on the plurality of purchase order descriptions 302. For example, a first embedding 306A can be generated based on the first purchase order description 302A, a second embedding 306B can be generated based on the second purchase order description 302B, a third embedding 306C can be generated based on the third purchase order description 302C, a fourth embedding 306D can be generated based on the fourth purchase order description 302D, and a fifth embedding 306E can be generated based on the fifth purchase order description 302E.

In some examples, the plurality of purchase order descriptions 302 are provided to a machine-learning model. In some examples, the machine-learning model is an LLM. In some examples, the machine-learning model is trained to generate a respective embedding for each purchase order description of the plurality of purchase order descriptions 302 that the machine-learning model receives. In some examples, the embeddings 306 are received from the machine-learning model. For example, the machine-learning model can be part of a software program, which systems described herein can interface with to generate the embeddings 306.

In some embodiments, the embeddings 306 are numerical representations of the purchase order descriptions 302 in the embedding space 308. In some embodiments, the embeddings 306 can allow a model, such as an LLM, to process and understand linguistic information in a way that captures semantic meaning (e.g., abstract language meaning) and relationships between data. In some examples, the relationships between data includes similarities in semantic meaning, which can be captured based on proximity between the embeddings 306A-E within the embedding space 308. For example, the embedding 306A for “cable” can be close to the embedding 306B “cabele” in the embedding space 308 because since “cabele” is just a misspelling of the word “cable”, the two embeddings are intended to have a similar semantic meaning.

According to some embodiments, the flow 300 includes clustering the embeddings 306. For example, the embeddings 306 can be clustered based on their proximity in distance to each other within the embedding space 308. As mentioned above, the embedding 306A for “cable” can be close to the embedding 306B “cabele” in the embedding space 308 because since “cabele” is just a misspelling of the word “cable”, the two embeddings are intended to have a similar semantic meaning. In some examples, the embedding 306A for “cable” and the embedding 306B for “cabele” therefore form a first cluster 310A.

In some examples, the embedding 306C for “bread” forms a second cluster 310B because it is semantically different enough from the other embeddings 306A-B and 306D-E, such that it should not be clustered with them. In some examples, being semantically different enough means being far enough in distance from the other embeddings, as compared to a threshold. In some examples, the embeddings 306D and 306E can be relatively close together within the embedding space 308 because they are both types of fruits. In some examples, different types of fruits are more semantically similar to each other than bread and/or electronic hardware, such as cables. In some examples, the embeddings 306D and 306E can form a third cluster 310C, based on their semantic similarity (e.g., sharing a similar abstract meaning, which therefore caused their embeddings 306D-E to be close in proximity to each other within the embedding space 308).

According to some embodiments, the flow 300 includes categorizing the clusters 310A-C. For example, using a machine-learning model (e.g., LLM), labels 312 (e.g., names or other identifiers) for the clusters 310 can be identified, such as a first label 312A for the first cluster 310A, a second label 312B for the second cluster 310B, and a third label 312C for the third cluster 310C.

In some examples, the names for the clusters 310A-C can describe the semantic similarity of the products represented by the clusters 310A-C. For example, since the first cluster 310A represents the purchase order descriptions “cable” and “cabele”, the first label 312A can be “cables” to capture the semantic similarity between the purchase order descriptions encompassed by the first cluster 310A. As another example, since the second cluster 310B represents the purchase order descriptions “Apple” and “Banana”, the second label 312B can be “Fruits” to capture the semantic similarity between the purchase order descriptions encompassed by the second cluster 310B. As another example, since the third cluster 310C represents the purchase order description “Bread”, the third label 312C can be “Bread” to capture the semantic similarity between the purchase order descriptions encompassed by the third cluster 310C.

According to some embodiments, the flow 300 includes generating a hierarchical representation 316. In some examples, the labels 312 form a first tier in the hierarchical representation. In some examples, the labels 312 are provided as inputs to a machine-learning model to create new embeddings 306, cluster the new embeddings 306 into new clusters 310, and create new labels 312 for the new clusters 310, such that the new labels 312 form another tier in the hierarchical representation. In some examples, aspects of flow 300 can be iteratively repeated a plurality of times, using the labels 312 of a current iteration as an input to a subsequent iteration, to generate a plurality of tiers. In some examples, the labels 312 of a current iteration of the flow 300 forms child nodes for labels generated by an immediately subsequent iteration. In some examples, the labels 312 of a current iteration of the flow 300 form parent nodes for labels generated by an immediately preceding iteration.

In some examples, aspects of the flow 300 can be repeated until the hierarchical representation 316 converges to a single node. For example, if only a single cluster 310 is generated by the clustering step of the flow 300, then only a single label 312 will be generated by the categorization step of the flow 300, such that the hierarchical representation 316 converges to a single node.

In some examples, the hierarchical representation 316 includes a tree, such as is shown in FIG. 3. In some examples, the hierarchical representation includes a graph and/or a table. In some examples, the hierarchical representation (e.g., including the tree, graph, and/or table) is displayed on a user interface, such as is shown in FIGS. 4 and/or 5.

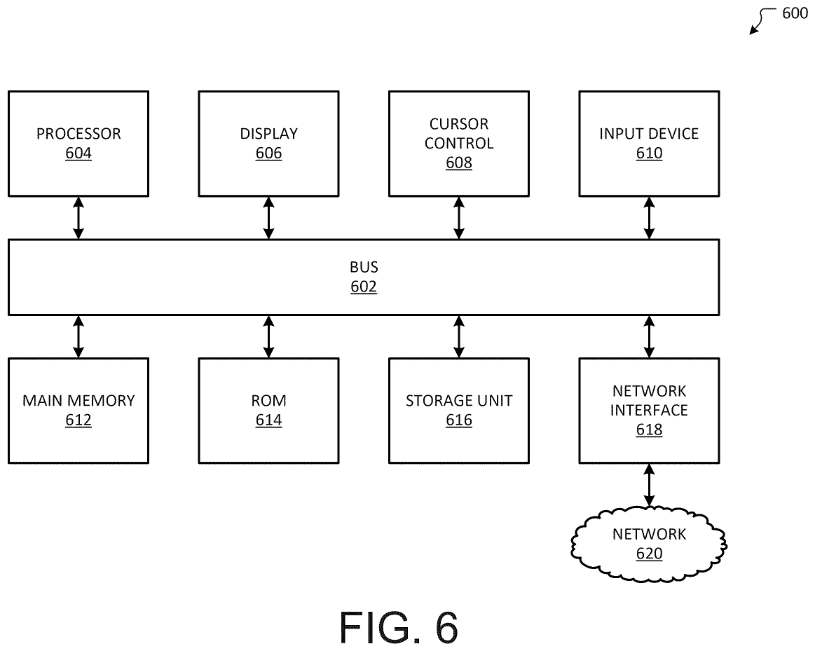

FIG. 4 illustrates an example user interface 400, according to certain embodiments of the present disclosure. In some examples, the user interface 400 is a graphical user interface (GUI). In some examples, the user interface 400 is displayed on a computing device, such as the computing device 202 of FIG. 2 and/or display 606 of FIG. 6.

In some examples, the user interface 400 includes a hierarchical representation 402, such as may be generated using techniques described herein. In some examples, the hierarchical representation 402 is a tree. In some examples, the tree 402 includes a plurality of tiers, such as a first tier 404, a second tier 406, and a third tier 408. In some examples, the tree 402 can include additional and/or fewer tiers than those illustrated in FIG. 4.

In some examples, each tier 404-408 includes a plurality of nodes. For example, the first tier 404 includes a first node 404A. As another example, the second tier 406 includes a first node 406A, a second node 406B, and a third node 406C. As another examples, the third tier 408 includes a first node 408A, a second node 408B, a third node 408C, a fourth node 408D, a fifth node 408E, a sixth node 408F, a seventh node 408G, an eighth node 408H, and a ninth node 408I. Those of ordinary skill in the art should recognize that additional and/or alternative types of nodes, numbers of nodes, and/or connections between nodes may be present on other hierarchical representations generated in accordance with techniques provided herein.

In some examples, the first node 404A of the first tier 404 is a parent node of the first node 406A, the second node 406B, and the third node 406C of the second tier 406. In some examples, the first node 404A can include a label, category, or description that is broad enough to capture the semantic similarity (e.g., overarching abstract linguistic meaning) of the first node 406A, the second node 406B, and the third node 406C of the second tier 406.

In some examples, the first node 406A of the second tier 406 is a parent node of the first node 408A, the second node 408B, and the third node 408C of the third tier 408. In some examples, the first node 406A can include a label, category, or description that is broad enough to capture the semantic similarity (e.g., overarching abstract linguistic meaning) of the first node 408A, the second node 408B, and the third node 408C of the third tier 408. In some examples, the second node 406B of the second tier 406 is a parent node of the fourth node 408D, the fifth node 408E, and the sixth node 408F of the third tier 408. In some examples, the second node 406B can include a label, category, or description that is broad enough to capture the semantic similarity (e.g., overarching abstract linguistic meaning) of the fourth node 408D, the fifth node 408E, and the sixth node 408F of the third tier 408. In some examples, the third node 406C of the second tier 406 is a parent node of the seventh node 408G, the eighth node 408H, and the ninth node 408I of the third tier 408. In some examples, the third node 406C can include a label, category, or description that is broad enough to capture the semantic similarity (e.g., overarching abstract linguistic meaning) of the seventh node 408G, the eighth node 408H, and the ninth node 408I of the third tier 408.

In some examples, parent and child nodes in the hierarchical representation 402 are connected via an edge. In some examples, the user interface 400 can receive input from a user to edit the hierarchical representation 402. For example, a user can provide input to edit a label, category, and/or description of the nodes 404A, 406A-C, and/or 408A-I. In some examples, a user can provide input to edit a relationship between two or more nodes. For example, a child node of the first node 406A in the second tier can be reassigned to be a child node of the second node 406B in the second tier. In some examples, the user input can be used to update training of a machine-learning model that was used to generate one or more aspects of the hierarchical representation, such that the user's input is used to supervise training of the machine-learning model (e.g., thereby modifying what future output of the machine-learning model may be, based on the user input).

In some examples, a user can perform zoom functions and/or scroll functions to navigate the hierarchical representation 402 on the user interface 400. In some examples, graphics of the user interface 400 are configurable by a user. For example, while the nodes 404A, 406A-C, and 408A-I are shown to include text descriptions in FIG. 4, in some examples the nodes 404A, 406A-C, and 408A-I can include colors, icons, animations, images, and/or other graphical representations.

In some examples, the user interface 400 is provided to a first type of user. For example, if a user is technically sophisticated user, then that may want to see the hierarchical representation 402 as a tree, as is illustrated in the user interface 400. In some examples, users may be associated with accounts, and hierarchical representations can be displayed to users based on the user's accounts. For example, if a user is an engineer or technical analyst, then the user's account may indicate that the user is an engineer or technical analyst, and provide the tree 402 to the user, based on their account status as an engineer or technical analyst.

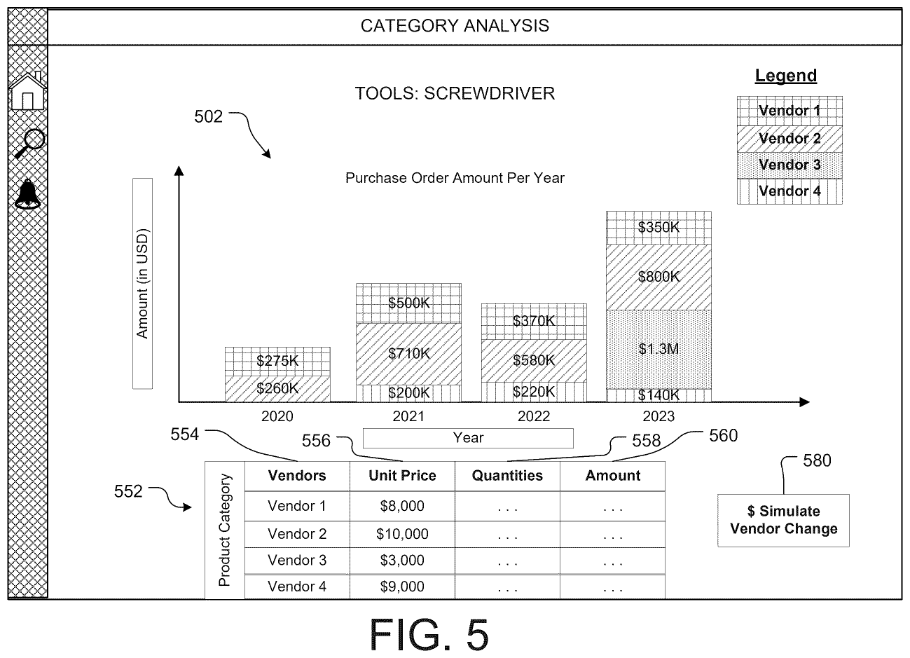

In some examples, a different user interface may be provided a type of user other than the first type of user, to present a hierarchical representation in a different form, as will be discussed in further detail with respect to FIG. 5.

FIG. 5 illustrates an example user interface 500, according to certain embodiments of the present disclosure. In some examples, the user interface 500 is a graphical user interface (GUI). In some examples, the user interface 500 is displayed on a computing device, such as the computing device 202 of FIG. 2 and/or display 606 of FIG. 6.

In some examples, the user interface 500 includes a hierarchical representation (see FIGS. 3 and/or 4), such as may be generated using techniques described herein. In some examples, the user interface includes graphics and/or analysis generated based on the hierarchical representation. For example, the user interface 500 includes a graph 502 and a table 552 generated based on a hierarchical representation, such as the hierarchical representation 316 of FIGS. 3 and/or 402 of FIG. 4. In some examples, the user interface 500 is generated based on input provided to the user interface 300 (such as a selection of one the nodes 404A, 406A-C, or 408A-I). In some examples, the user interface 500 is generated independent of the user interface 400. In some examples, the user interface 500 can be customized to include certain graphics and/or analyses that a user desires to view.

In some examples, the graph 502 includes a bar graph, a line graph, a pie chart, and/or another type of graph that may be recognized by those of ordinary skill in the art. In the example of FIG. 5, the graph 502 is a bar graph plotting the purchase order amount per year of a product. In some examples, the graph 502 includes the purchase order amount per year of a product, broken up by vendors. For example, in 2020, $275,000 was spent purchasing screwdrivers from Vendor 1 and $260,000 was spent purchasing screwdrivers from Vendor 2. As another example, in 2021, $500,000 was spent purchasing screwdrivers from Vendor 1, $710,000 was spent purchasing screwdrivers from Vendor 2, and $200,000 was spent purchasing screwdrivers from Vendor 4.

In some examples, a user can select the granularity at which they analyze purchase orders, based on a hierarchical representation (e.g., the hierarchical representation 402). For example, while the graph 502 is a plot of screwdriver purchase order amounts per year, in some examples, a user can select to analyze purchase orders at a higher degree of abstraction. For example, using the hierarchical representation 402 of FIG. 4, “Tools” is the broader encompassing category (e.g., parent node) of “Screwdriver.” In some examples, a user can choose to analyze the purchase order amount of tools per year (e.g., instead of and/or in addition to screwdrivers). Referring again to the hierarchical representation 402, in some examples “Construction Supplies” is the broader encompassing category (e.g., parent node) of “Tools.” In some examples, a user can choose to analyze the purchase order amount of construction supplies per year (e.g., instead of and/or in addition to tools). In some examples, the purchase order amount of construction supplies and/or tools can be broken up by vendors, such as in a similar manner as is illustrated by the graph 502.

In some examples, the table 552 includes a plurality of rows and columns for attributes about products described in the product hierarchy. For example, a first column 554 of the table 552 can include vendors for a product. Accordingly, information about the vendors can be aggregated from the purchase orders and/or independently provided to systems described herein. In some examples, a product can be procured from multiple different vendors, and those vendors can be listed in the first column 554. In some examples, a second column 556 of the table 552 includes unit prices for a product, such as by vendor. In some examples, a third column 558 of the table includes a quantity of units purchased of a product, such as by vendor. In some examples, a fourth column 560 of the table includes a total amount of money spent on a product, such as by vendor.

. It should be recognized by those of ordinary skill in the art that while the illustrated user interface 500 includes the table 552, other data structures can be used in addition to and/or instead of the table 552 to perform similar functionality. Further, while the table 552 includes a particular number of rows and columns, any other numbers of rows and/or columns can be configured for particular use cases.

In some examples, the user interface 500 includes an input feature 580. In some examples, the input feature 580 is a button, a slider, a textbox, a file upload, and/or another type of feature that is capable of receiving input from a user. In some examples, the input feature 580 is configured to simulate a vendor change. For example, a user can provide input to the input feature 580 to estimate the financial impact of changing one or more vendors for procuring one or more products.

In some examples, the input feature 580 can receive an indication of a change in price for a type of product ordered. For example, a user can simulate changes in costs, based on changing a price for a type of product ordered. In some examples, a cost difference for the quantity of the type of product ordered can be calculated, based on the change in price. In some examples, the cost difference for the quantity of the type of product ordered can be output (e.g., displayed), such as to notify a user of cost differences from changing the price of a product (e.g., from changing a vendor, negotiating a price change with a vendor, receiving a product discount, having prices increased, etc.). In some examples, information in the columns 554-560 can be updated based on the input provided to the input feature 580.

In some examples, the user interface 500 is provided to a different type of user than to whom the user interface 400 is provided. For example, if a user is less sophisticated user, then that may want to see the graph 502 and/or table 552, to analyze a hierarchical representation, as opposed to the tree 402 of FIG. 4. In some examples, users may be associated with accounts, and the user interface 500 can be displayed to users based on the user's accounts. For example, if a user is a procurement person and/or supply chain person, then the user's account may indicate that the user is an person and/or supply chain person, and techniques herein may provide the user interface 500 to the user, based on the user's account status, instead of and/or in addition to providing the user interface 400.

According to some embodiments, techniques provided herein are beneficial to improve performance of should costing, demand planning, supplier risk analyses, and/or vendor change implications. For example, during tenders, knowledge about the price of similar and/or the same products being tendered can be used to estimate costs. As another example, based on prior purchases of certain products and planned projects, a consumption of materials can be estimated for the future. In some examples, a planned demand for materials can be compared with a current stock and/or prior orders.

As another example, companies often purchase multiple products for a same category of products from a same supplier. In some examples, if the supplier is unable to fulfill orders, it can be a major risk for not just a particular product, but the entire product category in which that particular product is grouped. In some examples, the impact of the supplier's inability to fulfill orders can be calculated and actions for mitigations can be recommended and/or taken. As another example, if a company decided to discontinue their business relationship with a vendor, techniques provided herein can indicate which products would have to be reprocured.

In some examples, a procurement department of a company may use different enterprise resource programs (ERP) with different people inputting different descriptions for different materials. In such examples, analyzing inputs about products is incredibly difficult because there can be a lot of different products in the ERP which are all really the same or very similar products, but with different naming, different item numbers, or other different identifiers. In some examples, it may be difficult for a company using such an ERP system to accurately and quickly determine how much they spent last year purchasing a particular type of product (e.g., cables, screws, red paint, etc.). Without accurate estimates of how much was spent last year purchasing the particular products, it may be difficult, if not impossible, to accurately determine how much of the particular type of product should be ordered for next year.

In some examples, mechanisms provided herein can group together purchase orders that are the same or notably similar, and then create a hierarchical representation of these newly created groups of purchase orders to solve any of a variety of different problems.

In some examples, within a procurement domain, there can be purchase orders that happen every day, and there can be potentially millions of purchase orders over a time span of a couple of years. In some examples, each purchase order can include a text description and/or name in an ERP system that creates a relatively large amount of unstructured information. Such unstructured information can be difficult to analyze, but rather in some examples may be beneficial just for tracking the purchase order in the moment of the purchase.

In some examples, within the material management domain, similar problems may arise as in the procurement domain. In some examples, conventional material management systems rely on manual human input in the systems to track the products. In some examples, the conventional systems operate for decades and grow over time into a relatively large data stack that is not really accessible to easily analyze. In some examples, trying to find entities that belong together and that actually mean the same thing, within such a large data stack, is incredibly inefficient in terms of time and computing resources.

In some examples, for procurement of materials, organizing the materials within a system is a multi-dimensional problem because it may not be desirable to only group materials together by similarity (e.g., all pencils), but rather it may be desirable to group them into subcategories as well (e.g., black pencils, red pencils, green pencils, etc.). In some examples, costs can be associated with the subcategories to see how much money was spent on the materials in the subcategories (e.g., for the black pencils vs. red pencils vs. green pencils). In some examples, costs can be determined for various levels of abstraction for categorizing products (e.g., black pencils, pencils, writing utensils, supplies, etc.), using a hierarchical framework.

In some examples, the hierarchical representation can be a hierarchical representation of purchase orders and/or products in the purchase orders. In some examples, the hierarchical representation can include construction supplies on a first tier, and then on a second tier include fasteners, paints, pipes, hand tools etc. In some examples, the items on the second tier can have subcategories in a third or subsequent tier, such as a screwdriver, a screwdriver in German, and a hammer. In some examples, mechanism herein provide the ability to look at purchase orders that are grouped into certain categories and see a quantity of products in that category, a total cost of the products in that category, an average cost per unit of products in that category, etc. In some examples, mechanisms herein include workflows for simulating a vendor change. For example, given a list of vendors that also sell screwdrivers, calculations can be performed for the different vendors on the list to see how much money would be saved/lost with the different vendors. In some examples, techniques provided herein can be used for tracking costs, determining when to order products, tracking inventory, and other material management purposes.

In some examples, different purchase orders can include different descriptions for the same products. In some examples, different purchase orders can include different languages, while describing the same products. In some examples, purchase orders may not explicitly state what product the purchase order is for, but have vendor information or other contextual information (e.g., product numbers, abbreviations, nicknames, costs, quantities, etc.) indicative of what product the purchase order is for.

In such examples, the purchase orders can be difficult for conventional text processing systems to analyze; however, using techniques provided herein, the purchase orders can be efficiently analyzed, clustered, and categorized for including in a hierarchical representation.

In some examples, techniques provided herein can receive an unordered list of purchase order descriptions. For example, the purchase order descriptions can include product descriptions, such as cable, cable with a spelling error, red apple, banana, etc. In some examples, the techniques include computing embeddings of the descriptions to convert the descriptions into a vector space. For example, the vector space can then represent the semantics of the purchase orders.

In some examples, an LLM can understand what product a purchase order description is referring to, even if there is not explicit product name. For example, based on a product number, shorthand label, vendor, cost, or the like, the LLM can determine what product the purchase order is associated with based on semantic context (e.g., abstract meaning ascertained from the contextual information of the purchase order). In some examples, if embeddings are spaced relatively close to each other, then the embeddings are related. For example, embeddings for a banana and an apple can be close to each other because they are both fruits and share a similar semantic context (e.g., the abstract understanding of language that includes both items are a type of fruit). In some examples, a clustering algorithm can be run on the embeddings to determine whether and/or how related the embeddings are to each other, based on a semantic context (e.g., abstract language meaning) associated with the embeddings.

In some examples, LLMs used herein are trained on the semantics of words. For example, the LLM may be trained to understand that a banana is somewhat similar to an apple, but a cable is dissimilar from a banana. In some examples, an LLM receives text and outputs a vector representation (e.g., embedding) of the text. In some examples, the LLM has be trained to create an embedding space where semantically similar words (e.g., words with similar abstract meanings) are relatively closer to each other in the embedding space than semantically dissimilar words. In examples, the words “screwdriver” in English and the same word in German may be very close to each other in the embeddings space because they share a common meaning, but in different languages. In such examples, the LLM can understand both languages and know that the words are semantically the same thing, and therefore assign them vector representations that are close together.

In some examples, an LLM model can be switched out with another LLM model, such as due to accuracy of the different LLM models in different use cases. For example, a first LLM model may be better (e.g., more accurate) at generating embeddings over a variety of languages than a second LLM model. As another example, a first LLM model may be better (e.g., more accurate) at generating embeddings for a particular language than a second LLM model, such that if a description is provided in the particular language, systems provided herein will know to switch to the first LLM model for generating an embedding.

In some examples, entire purchase orders may be converted into respective embeddings. In some examples, one or more descriptions from the purchase orders may be converted into one or more embeddings.

In some examples, if an LLM is unsure about what is the semantic meaning behind a description, the LLM can assign the description to an uncategorized category. For example, the uncategorized category can be useful for human review, to manually assign a category/label to the description (and/or embedding associated with the description). In some examples, the system may provide a notification to prompt the human review and receive an input from a user that includes the category/label for the description. In some examples, systems provided herein include tools to modify outputs from an LLM and/or provide feedback to the LLM to supervise training of the LLM on real use cases.

In some examples, the LLM can assign embeddings to certain groups based on confidence levels. For example, if embeddings are within a certain distance from each other, then the embeddings may have a corresponding confidence level indicating whether the embeddings are related. In some examples, the distance between embeddings may be compared to a threshold to determine whether the embeddings are sufficiently related to each other.

In some examples, a clustering algorithm can be run on embeddings in the vector space. For example, the clusters can represent groups of embeddings/vectors that are semantically related to each other (e.g., have a similar abstract meaning). In some examples, the system can run an outlier detection in the embedding space to determine if any vectors/embeddings do not match into a particular group. In some examples, a system can check the outliers and/or groups of embeddings to determine whether they make sense. For example, if an electronic device is put in the same group as a banana, then the system may flag that group as being potentially inaccurate. In some examples, if a reasonable description cannot be made to capture all of the embeddings in a particular group, then the group may need to be split into multiple groups, such that each group can be assigned a reasonable category description (e.g., label).

In some examples, a plurality of purchase order descriptions can be used to create corresponding embeddings and the embeddings can be clustered based on a semantic similarity of the embeddings to each other. In some examples, each of the clusters of embeddings are assigned a label, by an LLM, that describes the semantic grouping of the embeddings (e.g., electronics for multiple products that are types of electronics, fruits for multiple products that are types of fruits, bolts for multiple products that are types of bolts, etc.). In some examples, the label includes a single word. In some examples, the label includes a plurality of words. In some examples, the purchase order descriptions and/or embeddings are input into the LLM to output the label for the cluster of embeddings corresponding to the purchase order descriptions.

In some examples, the descriptions/labels for the clusters are fed into the LLM to determine semantic similarities between the descriptions/labels and create clusters. In such examples, labels can be determined for this second iteration of cluster generations. In some examples, the labels generated from the first iteration of cluster generations is a first tier of a hierarchical representation and the labels generated from the second iteration of cluster generations is a second tier of a hierarchical representation. In some examples, a base tier of a hierarchical representation contains the greatest detail about products in purchase orders and a highest tier of the hierarchical representation (e.g., furthest from the base tier) contains the most abstract detail about the products in the purchase orders, such that a user can traverse the different tiers of the hierarchical representation to obtain different degrees of detail about the products in the purchase orders.

In some examples, to generate the hierarchy, the system feeds the labels for the categories of embeddings back into an embedding generator to create embeddings for the labels. In some examples, the embeddings for the labels are then clustered and categorized into another tier of groups, with labels determined by an LLM to be assigned to the groups. In some examples, each iteration of generating labels for categories of embeddings corresponds to a different tier in the hierarchical representation. In some examples, the iterative process converges until a base case where there is only one cluster of embeddings, and that one cluster of embeddings corresponds to the top level of the hierarchy. In some examples, the hierarchy may have two levels, or three levels, or four levels, or any number of levels. In some examples, the amount of levels (e.g., tiers) may be configurable, such that the hierarchy will always have at most a certain number of levels and/or at least a certain number of levels.

In some examples, the clustering of the embeddings is performed based on vector distances between embeddings. In some examples, the clustering algorithm is a K-means clustering algorithm. In some examples, the clustering algorithm is a non-linear clustering algorithm. In some examples, the clustering algorithm that is used may be configurable, such that a first clustering algorithm is used in some instances and a second clustering algorithm is used in other instances.

In some examples, LLMs used according to the disclosed techniques have a degree of randomness. In some examples, LLMs can be run multiple times with the same prompt (e.g., five times), to receive multiple answers from the same prompt. In such examples, the multiple answers can have some variation. In some examples, the multiple answers can be provided to an LLM (e.g., an LLM acting in a supervisory role over the provided answers), such that the LLM can look at the multiple answers and determine which answer is the best (e.g., most consistent with the other answers, in terms of the abstract semantic meaning being encompassed by the answers). In some examples, the best answer is the answer that appears most often. In some examples, the best answer is the answer that is closest in semantic similarity to each and/or most of the other answers.

In some examples, when an embedding model is provided with a prompt to create an embedding, if the same prompt is provided multiple, then the same embedding will be provided multiple times in response to the same prompt. In some examples, when an LLM is provided with multiple embeddings to generate a cluster and/or categorization, the LLM may provide different outputs on two different instances of being provided with the same multiple embeddings, such as due to the degree of randomness in LLM processing. In some examples, using an LLM in a supervisory role over the previously provided answers from one or more LLMs can help to ensure consistency and/or accuracy in LLM outputs. For example, using the LLM in the supervisory role can improve the consistency and/or accuracy of downstream processing.

In some examples, techniques provided herein can reduce and/or minimize hallucinations created by LLMs. For example, techniques provided herein can be operating on potential huge data sets, such as millions of purchase orders and purchase order products. In some examples, even a small percentage of hallucinations can negatively impact processing, when the processing is performed at scale. In some examples, using supervisory LLMs and/or multiple iterations of LLM processes described herein (e.g., in a clustering, categorization, and/or labelling step), helps to reduce a degree of hallucinations created by LLMs to improve the consistency and/or accuracy of processing described herein. In some examples, having an undefined bucket for embeddings (e.g., in a clustering, categorization, and/or labelling step) can be another option for reducing a degree of hallucinations.

In some examples, LLM processes described herein are back-end processing. For example, one or more LLM processes (e.g., generating embeddings, clustering, categorizing, creating hierarchies) may not directly interface with a user. In some examples, a user may provide purchase orders and/or product descriptions to a user interface and receive a hierarchical representation and/or related analytics, such as from a back-end LLM pipeline that processed the provided purchase orders and/or product descriptions. In some examples, a user may indirectly interact with an LLM.

In some examples, users can provide hierarchical feedback to assist/supervise an LLM in creating a hierarchical representation. For example, a user can describe how they want a particular product called by a particular name (e.g., a cable should be called a rope, food should be called fuel, or other context-driven descriptions). As another example, a user can describe how they want particular products grouped together in particular groups (e.g., instead of apples and bananas being grouped together as fruit, apples and cables may be grouped together as being associated with a first businesses, while bananas are grouped separately as being associated with a second business).

In some examples, upon receiving the hierarchical representation, a user may be able to manually edit the hierarchical representation. For example, a user may be able to relabel certain categories, redirect edges, reassign products to different groups, or other manual edits that may be recognized by those of ordinary skill in the art. In some examples, the user's edits can be used to train the system to provide outputs in accordance with the user's edits, in future processing. In some examples, user intervention can be a form of supervising learning for techniques provided herein. In some examples, the user intervention is provided via a selection, text-input, audio-input, gaze-input, gesture-input, or any other type of user input that may be recognized by those of ordinary skill in the art. In some examples, one or more user interface features (e.g., text box, file upload, button, camera, touchscreen, etc.) may be provided for a user to provide their user input.

In some examples, after a hierarchical representation is generated, new purchase orders can be received by the system, and the hierarchical representation can be updated based on the new purchase orders. For example, new categories may added based on the new purchase orders, new edges may be created between categories, and new metrics may be calculated based on the purchase orders. In some examples, additional and/or alternatives modifications that may be made when new purchase orders are received may be recognized by those of ordinary skill in the art.

In some examples, different hierarchical representations can be generated for different types of users. For example, a tree structure can be generated for a first type of user (e.g., a technically sophisticated user). In some examples, the first type of user may be more interested than the second type of user in hierarchical relationships between different types of products. In some examples, a bar graph and/or table can be generated for a second type of user (e.g., a buyer). For example, the second type of user may be more interested than the first type of user in prices for products described in the hierarchical representation. In such examples, graphical representations communicating pricing information can be generated for the second type of user.

FIG. 6 is a simplified diagram showing a computing system for implementing a system 600 for generating a hierarchical representation of a plurality of products in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of methods and/or processes disclosed herein are performed by the computing system 600. In some embodiments, the bus 602 is coupled to the processor 604, the display 606, the cursor control component 608, the input device 610, the main memory 612, the read only memory (ROM) 614, the storage unit 616, and/or the network interface 618. In certain embodiments, the network interface is coupled to a network 620. For example, the processor 604 includes one or more general purpose microprocessors. In some embodiments, the main memory 612 (e.g., random access memory (RAM), cache and/or other dynamic storage devices) is configured to store information and instructions to be executed by the processor 604. In certain embodiments, the main memory 612 is configured to store temporary variables or other intermediate information during execution of instructions to be executed by processor 604. For example, the instructions, when stored in the storage unit 616 accessible to processor 604, render the computing system 600 into a special-purpose machine that is customized to perform the operations specified in the instructions. In some embodiments, the ROM 614 is configured to store static information and instructions for the processor 604. In certain embodiments, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some embodiments, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for generating a hierarchical representation of a plurality of products is provided. In some examples, the method includes (a) receiving a plurality of purchase orders comprising a plurality of descriptions. In some examples, each purchase order of the plurality of purchase orders includes at least one description of the plurality of descriptions. In some examples, the method further includes (b) providing the plurality of descriptions of the plurality of purchase orders to a machine-learning model. In some examples, the machine-learning model is trained to generate a respective embedding for each description of the plurality of descriptions of the plurality of purchase orders. In some examples, the method further includes (c) receiving, from the machine-learning model, a plurality of embeddings. In some examples, each embedding of the plurality of embeddings corresponds to a respective description of the plurality of descriptions of the plurality of purchase orders. In some examples, the method further includes (d) clustering the plurality of embeddings into one or more embedding subsets based on a semantic similarity between each embedding of the plurality of embeddings and each other embedding of the plurality of embeddings. In some examples, each embedding subset of the one or more embedding subsets includes one or more embeddings of the plurality of embeddings. In some examples, the method further includes (e) identifying, using a large language model, a plurality of labels for the plurality of embedding subsets. In some examples, each label of the plurality of labels corresponds to a respective embedding subset of the plurality of embedding subsets, and each label of the plurality of labels indicates the respective embedding subset of the plurality of embedding subsets for which the label was identified. In some examples, steps (b) through (e) are repeated at least once, using the plurality of labels from the latest iteration of step (e) as the plurality of descriptions in step (b). In some examples, the method further includes (g) generating the hierarchical representation of the plurality of purchase orders. In some examples, the plurality of labels from the first iteration of steps (b) through (e) form a first tier in the hierarchical representation, and the plurality of labels from each subsequent iteration of steps (b) through (e) form a respective other tier in the hierarchical representation. The method is performed using one or more processors. For example, the method is implemented according to at least FIG. 1, FIG. 2, FIG. 3, FIG. 4, FIG. 5, and/or FIG. 6.

In some embodiments, the description for the each purchase order includes at least one product description and at least one vendor description. In some embodiments, the clustering includes: determining the semantic similarity between each embedding of the plurality of embeddings and each other embedding of the plurality of embeddings; comparing the semantic similarity between each embedding of the plurality of embeddings and each other embedding of the plurality of embeddings to a predetermined threshold; and assigning the plurality of embeddings to the one or more embedding subsets based on the comparison of the semantic similarity between each embedding of the plurality of embeddings and each other embedding of the plurality of embeddings to the predetermined threshold. In some embodiments, the repeating steps (b) through (e) using the plurality of labels from the latest iteration of step (e) as the plurality of descriptions in step (b) includes repeating steps (b) through (e) until the clustering the plurality of embeddings into the one or more embedding subsets based on the semantic similarity includes clustering the plurality of embeddings into only one embedding subset based on the semantic similarity.

In some embodiments, the hierarchical representation includes a graph, and the method further comprises causing the graph to be displayed on a user interface. In some embodiments, the method further includes identifying a quantity of a type of product ordered, based on a label of the plurality of labels in at least one tier of the hierarchical representation identifying the type of product ordered and how many embeddings corresponding to the plurality of descriptions of the plurality of purchase orders are in the embedding subset encompassed by the label. In some embodiments, the method further includes: receiving, via a user interface, an indication of a change in price for the type of product ordered; calculating a cost difference for the quantity of the type of product ordered, based on the change in price; and outputting the cost difference for the quantity of the type of product ordered.

In some embodiments, the method further includes selecting the large language model from a plurality of different large language models. In some embodiments, the method further includes causing a first user interface based on the hierarchical representation of the plurality of purchase orders to be displayed to a first type of user; and causing a second user interface based on the hierarchical representation of the plurality of purchase orders to be displayed to a second type of user.

According to certain embodiments, a system for generating a hierarchical representation of a plurality of purchase orders is provided. In some examples, the system includes one or more processors, and one or more memories storing instructions that, when executed by the one or more processors, cause the system to perform a set of operations. In some examples, the set of operations include: (a) receiving a plurality of purchase orders comprising a plurality of descriptions. In some examples, each purchase order of the plurality of purchase orders includes at least one description of the plurality of descriptions. In some examples, the set of operations further includes (b) providing the plurality of descriptions of the plurality of purchase orders to a machine-learning model. In some examples, the machine-learning model is trained to generate a respective embedding for each description of the plurality of descriptions of the plurality of purchase orders. In some examples, the set of operations further includes (c) receiving, from the machine-learning model, a plurality of embeddings. In some examples, each embedding of the plurality of embeddings corresponds to a respective description of the plurality of descriptions of the plurality of purchase orders. In some examples, the set of operations further includes (d) clustering the plurality of embeddings into one or more embedding subsets based on a semantic similarity between each embedding of the plurality of embeddings and each other embedding of the plurality of embeddings. In some examples, each embedding subset of the one or more embedding subsets includes one or more embeddings of the plurality of embeddings. In some examples, the set of operations further includes (e) identifying, using a large language model, a plurality of labels for the plurality of embedding subsets. In some examples, each label of the plurality of labels corresponds to a respective embedding subset of the plurality of embedding subsets, and each label of the plurality of labels indicates the respective embedding subset of the plurality of embedding subsets for which the label was identified. In some examples, operations (b) through (e) are repeated at least once, using the plurality of labels from the latest iteration of operation (e) as the plurality of descriptions in operation (b). In some examples, the set of operations further includes (g) generating the hierarchical representation of the plurality of purchase orders. In some examples, the plurality of labels from the first iteration of operations (b) through (e) form a first tier in the hierarchical representation, and the plurality of labels from each subsequent iteration of operations (b) through (e) form a respective other tier in the hierarchical representation. For example, the system is implemented according to at least FIG. 1, FIG. 2, FIG. 3, FIG. 4, FIG. 5, and/or FIG. 6.

In some embodiments, the description for the each purchase order includes at least one product description and at least one vendor description. In some embodiments, the clustering includes: determining the semantic similarity between each embedding of the plurality of embeddings and each other embedding of the plurality of embeddings; comparing the semantic similarity between each embedding of the plurality of embeddings and each other embedding of the plurality of embeddings to a predetermined threshold; and assigning the plurality of embeddings to the one or more embedding subsets based on the comparison of the semantic similarity between each embedding of the plurality of embeddings and each other embedding of the plurality of embeddings to the predetermined threshold. In some embodiments, the repeating operations (b) through (e) using the plurality of labels from the latest iteration of operation (e) as the plurality of descriptions in operation (b) includes repeating operations (b) through (e) until the clustering the plurality of embeddings into the one or more embedding subsets based on the semantic similarity includes clustering the plurality of embeddings into only one embedding subset based on the semantic similarity.

In some embodiments, the hierarchical representation includes a graph, and the set of operations further includes causing the graph to be displayed on a user interface. In some embodiments, the set of operations further includes identifying a quantity of a type of product ordered, based on a label of the plurality of labels in at least one tier of the hierarchical representation identifying the type of product ordered and how many embeddings corresponding to the plurality of descriptions of the plurality of purchase orders are in the embedding subset encompassed by the label. In some embodiments, the set of operations further includes: receiving, via a user interface, an indication of a change in price for the type of product ordered; calculating a cost difference for the quantity of the type of product ordered, based on the change in price; and outputting the cost difference for the quantity of the type of product ordered.

In some embodiments, the set of operations further includes selecting the large language model from a plurality of different large language models. In some embodiments, the set of operations further includes causing a first user interface based on the hierarchical representation of the plurality of purchase orders to be displayed to a first type of user; and causing a second user interface based on the hierarchical representation of the plurality of purchase orders to be displayed to a second type of user.

According to certain embodiments, a method for generating a hierarchical representation of a plurality of purchase orders is provided. In some examples, the method includes (a) receiving a plurality of purchase orders comprising a plurality of product descriptions. In some examples, each purchase order of the plurality of purchase orders includes at least one product description of the plurality of product descriptions. In some examples, the method further includes: (b) generating a plurality of embeddings. In some examples, each embedding of the plurality of embeddings corresponds to a respective product description of the plurality of product descriptions of the plurality of purchase orders. In some examples, the method further includes (c) clustering the plurality of embeddings into one or more embedding subsets based on a semantic similarity between each embedding of the plurality of embeddings and each other embedding of the plurality of embeddings. In some examples, each embedding subset of the one or more embedding subsets includes one or more embeddings of the plurality of embeddings. In some examples, the method further includes (d) categorizing, using a large language model, each embedding subset of the plurality of embedding subsets into a respective category of a plurality of categories. In some examples, each category of the plurality of categories corresponds to a respective embedding subset of the plurality of embedding subsets, and each category of the plurality of categories indicates the respective embedding subset encompassed by the category. In some examples, steps (b) through (d) are repeated at least once, using the plurality of categories from the latest iteration of step (d) as the plurality of descriptions in step (b). In some examples, the method further includes (f) generating the hierarchical representation of the plurality of purchase orders. In some examples, the plurality of categories from the first iteration of steps (b) through (d) form a first tier in the hierarchical representation, and the plurality of categories from each subsequent iteration of steps (b) through (d) form a respective other tier in the hierarchical representation. The method is performed using one or more processors. For example, the method is implemented according to at least FIG. 1, FIG. 2, FIG. 3, FIG. 4, FIG. 5, and/or FIG. 6.

In some examples, the method further includes identifying a quantity of a type of product ordered, based on a category of the plurality of categories in at least one tier of the hierarchical representation identifying the type of product ordered and how many embeddings corresponding to the plurality of product descriptions of the plurality of purchase orders are in the embedding subset encompassed by the category; calculating a cost difference for the quantity of the type of product ordered, based on a price change for the type of product ordered; and outputting the cost difference for the quantity of the type of product ordered.

For example, some or all components of various embodiments of the present disclosure each are, individually and/or in combination with at least another component, implemented using one or more software components, one or more hardware components, and/or one or more combinations of software and hardware components. In an example, some or all components of various embodiments of the present disclosure each are, individually and/or in combination with at least another component, implemented in one or more circuits, such as one or more analog circuits and/or one or more digital circuits. In an example, while the embodiments described above refer to particular features, the scope of the present disclosure also includes embodiments having different combinations of features and embodiments that do not include all of the described features. In an example, various aspects of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be removed from the combination, and a combination may, for example, be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for generating a hierarchical representation of a plurality of products, the method comprising:
(a) receiving a plurality of purchase orders comprising a plurality of descriptions, each purchase order of the plurality of purchase orders comprising at least one description of the plurality of descriptions;
(b) providing the plurality of descriptions of the plurality of purchase orders to a machine-learning model, the machine-learning model being trained to generate a respective embedding for each description of the plurality of descriptions of the plurality of purchase orders;
(c) receiving, from the machine-learning model, a plurality of embeddings, each embedding of the plurality of embeddings corresponding to a respective description of the plurality of descriptions of the plurality of purchase orders;
(d) clustering the plurality of embeddings into one or more embedding subsets based on a semantic similarity between each embedding of the plurality of embeddings and each other embedding of the plurality of embeddings, each embedding subset of the one or more embedding subsets including one or more embeddings of the plurality of embeddings;
(e) identifying, using a large language model, a plurality of labels for the plurality of embedding subsets, each label of the plurality of labels corresponding to a respective embedding subset of the plurality of embedding subsets, and each label of the plurality of labels indicating the respective embedding subset of the plurality of embedding subsets for which the label was identified;
(f) repeating steps (b) through (e) at least once, using the plurality of labels from the latest iteration of step (e) as the plurality of descriptions in step (b); and
(g) generating the hierarchical representation of the plurality of purchase orders, the plurality of labels from the first iteration of steps (b) through (e) forming a first tier in the hierarchical representation, and the plurality of labels from each subsequent iteration of steps (b) through (e) forming a respective other tier in the hierarchical representation,
wherein the method is performed using one or more processors.

2. The method of claim 1, wherein the description for the each purchase order includes at least one product description and at least one vendor description.

3. The method of claim 1, wherein the clustering includes:
determining the semantic similarity between each embedding of the plurality of embeddings and each other embedding of the plurality of embeddings;
comparing the semantic similarity between each embedding of the plurality of embeddings and each other embedding of the plurality of embeddings to a predetermined threshold; and
assigning the plurality of embeddings to the one or more embedding subsets based on the comparison of the semantic similarity between each embedding of the plurality of embeddings and each other embedding of the plurality of embeddings to the predetermined threshold.

4. The method of claim 1, wherein the repeating steps (b) through (e) using the plurality of labels from the latest iteration of step (e) as the plurality of descriptions in step (b) includes repeating steps (b) through (e) until the clustering the plurality of embeddings into the one or more embedding subsets based on the semantic similarity includes clustering the plurality of embeddings into only one embedding subset based on the semantic similarity.

5. The method of claim 1, wherein the hierarchical representation includes a graph, and wherein the method further comprises causing the graph to be displayed on a user interface.

6. The method of claim 1, further comprising:
identifying a quantity of a type of product ordered, based on a label of the plurality of labels in at least one tier of the hierarchical representation identifying the type of product ordered and how many embeddings corresponding to the plurality of descriptions of the plurality of purchase orders are in the embedding subset encompassed by the label.

7. The method of claim 6, further comprising:
receiving, via a user interface, an indication of a change in price for the type of product ordered;
calculating a cost difference for the quantity of the type of product ordered, based on the change in price; and
outputting the cost difference for the quantity of the type of product ordered.

8. The method of claim 1, further comprising:
selecting the large language model from a plurality of different large language models.

9. The method of claim 1, further comprising:
causing a first user interface based on the hierarchical representation of the plurality of purchase orders to be displayed to a first type of user; and
causing a second user interface based on the hierarchical representation of the plurality of purchase orders to be displayed to a second type of user.

10. A system for generating a hierarchical representation of a plurality of purchase orders, the system comprising:
one or more processors; and
one or more memories storing instructions that, when executed by the one or more processors, cause the system to perform a set of operations, the set of operations comprising:
(a) receiving a plurality of purchase orders comprising a plurality of descriptions, each purchase order of the plurality of purchase orders comprising at least one description of the plurality of descriptions;
(b) providing the plurality of descriptions of the plurality of purchase orders to a machine-learning model, the machine-learning model being trained to generate a respective embedding for each description of the plurality of descriptions of the plurality of purchase orders;
(c) receiving, from the machine-learning model, a plurality of embeddings, each embedding of the plurality of embeddings corresponding to a respective description of the plurality of descriptions of the plurality of purchase orders;
(d) clustering the plurality of embeddings into one or more embedding subsets based on a semantic similarity between each embedding of the plurality of embeddings and each other embedding of the plurality of embeddings, each embedding subset of the one or more embedding subsets including one or more embeddings of the plurality of embeddings;
(e) identifying, using a large language model, a plurality of labels for the plurality of embedding subsets, each label of the plurality of labels corresponding to a respective embedding subset of the plurality of embedding subsets, and each label of the plurality of labels indicating the respective embedding subset of the plurality of embedding subsets for which the label was identified;
(f) repeating operations (b) through (e) at least once, using the plurality of labels from the latest iteration of operation (e) as the plurality of descriptions in operation (b); and
(g) generating the hierarchical representation of the plurality of purchase orders, the plurality of labels from the first iteration of operations (b) through (e) forming a first tier in the hierarchical representation, and the plurality of labels from each subsequent iteration of operations (b) through (e) forming a respective other tier in the hierarchical representation.

11. The system of claim 10, wherein the description for the each purchase order includes at least one product description and at least one vendor description.

12. The system of claim 10, wherein the clustering includes:
determining the semantic similarity between each embedding of the plurality of embeddings and each other embedding of the plurality of embeddings;
comparing the semantic similarity between each embedding of the plurality of embeddings and each other embedding of the plurality of embeddings to a predetermined threshold; and
assigning the plurality of embeddings to the one or more embedding subsets based on the comparison of the semantic similarity between each embedding of the plurality of embeddings and each other embedding of the plurality of embeddings to the predetermined threshold.

13. The system of claim 10, wherein the repeating operations (b) through (e) using the plurality of labels from the latest iteration of operation (e) as the plurality of descriptions in operation (b) includes repeating operations (b) through (e) until the clustering the plurality of embeddings into the one or more embedding subsets based on the semantic similarity includes clustering the plurality of embeddings into only one embedding subset based on the semantic similarity.

14. The system of claim 10, wherein the hierarchical representation includes a graph, and wherein the method further comprises causing the graph to be displayed on a user interface.

15. The system of claim 10, wherein the set of operations further comprises:
identifying a quantity of a type of product ordered, based on a label of the plurality of labels in at least one tier of the hierarchical representation identifying the type of product ordered and how many embeddings corresponding to the plurality of descriptions of the plurality of purchase orders are in the embedding subset encompassed by the label.

16. The system of claim 15, wherein the set of operations further comprises:
receiving, via a user interface, an indication of a change in price for the type of product ordered;
calculating a cost difference for the quantity of the type of product ordered, based on the change in price; and
outputting the cost difference for the quantity of the type of product ordered.

17. The system of claim 10, wherein the set of operations further comprises:
selecting the large language model from a plurality of different large language models.

18. The system of claim 10, wherein the set of operations further comprises:
causing a first user interface based on the hierarchical representation of the plurality of purchase orders to be displayed to a first type of user; and
causing a second user interface based on the hierarchical representation of the plurality of purchase orders to be displayed to a second type of user.

19. A method for generating a hierarchical representation of a plurality of purchase orders, the method comprising:
(a) receiving a plurality of purchase orders comprising a plurality of product descriptions, each purchase order of the plurality of purchase orders comprising at least one product description of the plurality of product descriptions;
(b) generating a plurality of embeddings, each embedding of the plurality of embeddings corresponding to a respective product description of the plurality of product descriptions of the plurality of purchase orders;
(c) clustering the plurality of embeddings into one or more embedding subsets based on a semantic similarity between each embedding of the plurality of embeddings and each other embedding of the plurality of embeddings, each embedding subset of the one or more embedding subsets including one or more embeddings of the plurality of embeddings;
(d) categorizing, using a large language model, each embedding subset of the plurality of embedding subsets into a respective category of a plurality of categories, each category of the plurality of categories corresponding to a respective embedding subset of the plurality of embedding subsets, and each category of the plurality of categories indicating the respective embedding subset encompassed by the category;
(e) repeating steps (b) through (d) at least once, using the plurality of categories from the latest iteration of step (d) as the plurality of descriptions in step (b); and
(f) generating the hierarchical representation of the plurality of purchase orders, the plurality of categories from the first iteration of steps (b) through (d) forming a first tier in the hierarchical representation, and the plurality of categories from each subsequent iteration of steps (b) through (d) forming a respective other tier in the hierarchical representation,
wherein the method is performed using one or more processors.

20. The method of claim 19, further comprising:
identifying a quantity of a type of product ordered, based on a category of the plurality of categories in at least one tier of the hierarchical representation identifying the type of product ordered and how many embeddings corresponding to the plurality of product descriptions of the plurality of purchase orders are in the embedding subset encompassed by the category;
calculating a cost difference for the quantity of the type of product ordered, based on a price change for the type of product ordered; and
outputting the cost difference for the quantity of the type of product ordered.
